(19) United States
(12) Patent Application Publication
(10) Pub. No.: US 2026/0333512 A1
(43) Pub. Date: Oct. 22, 2026

(54) RESOURCE CONFIGURATION WITH DISCONTINUOUS TRANSMISSION AND DISCONTINUOUS RECEPTION

(71) Applicant: Lenovo (United States) Inc., Morrisville, NC (US)

(72) Inventors: Khaled Nafez Rauf Ardah, Ilmenau (DE); Karthikeyan Ganesan, Nauheim (DE)

(73) Assignee: Lenovo (United States) Inc., Morrisville, NC (US)

(21) Appl. No.: 19/413,349

(22) Filed: Dec. 9, 2025

(51) Int. Cl. H04W 76/28; H04B 7/06

(52) U.S. Cl. CPC H04W 76/28; H04B 7/0626

(57) ABSTRACT

Various aspects of the present disclosure relate to resource configuration with discontinuous transmission (DTX) and discontinuous reception (DRX). A user equipment (UE) may receive first signaling that indicates a set of one or more resource configurations. Resource configurations of the set of one or more resource configurations are associated with respective DTX cycles and DRX cycles corresponding to a network equipment (NE). The UE receives second signaling that indicates a resource configuration of the set of one or more resource configurations and that indicates a DTX cycle and a DRX cycle of the respective DTX cycles and the DRX cycles. The UE transmits third signaling (e.g., one or more reference signals and/or measurement reports) to the NE based on the resource configuration and at least one of the DTX cycle or the DRX cycle.

### TECHNICAL FIELD

The present disclosure relates to wireless communications, and more specifically to configuring resources for wireless communications.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive first signaling that indicates a set of one or more resource configurations, where resource configurations of the set of one or more resource configurations are associated with respective discontinuous transmission (DTX) cycles and discontinuous reception (DRX) cycles corresponding to an NE, receive second signaling that indicates a resource configuration of the set of one or more resource configurations and that indicates a DTX cycle and a DRX cycle of the respective DTX cycles and the DRX cycles, and transmit third signaling based on the resource configuration and at least one of the DTX cycle or the DRX cycle.

A processor (e.g., a standalone processor chipset, or a component of a UE) for wireless communication is described. The processor may be configured to, capable of, or operable to perform one or more operations as described herein. For example, the processor may be configured to, capable of, or operable to receive first signaling that indicates a set of one or more resource configurations, where resource configurations of the set of one or more resource configurations are associated with respective DTX cycles and DRX cycles corresponding to an NE, receive second signaling that indicates a resource configuration of the set of one or more resource configurations and that indicates a DTX cycle and a DRX cycle of the respective DTX cycles and the DRX cycles, and transmit third signaling based on the resource configuration and at least one of the DTX cycle or the DRX cycle.

A method performed or performable by a UE for wireless communication is described. The method may include receiving first signaling that indicates a set of one or more resource configurations, where resource configurations of the set of one or more resource configurations are associated with respective DTX cycles and DRX cycles corresponding to an NE, receiving second signaling that indicates a resource configuration of the set of one or more resource configurations and that indicates a DTX cycle and a DRX cycle of the respective DTX cycles and the DRX cycles, and transmitting third signaling based on the resource configuration and at least one of the DTX cycle or the DRX cycle.

In some implementations of the UE, the processor, and the method described herein, the UE, the processor, and the method may further be configured to, capable of, or operable to receive, based on the DTX cycle, a channel state information (CSI)-reference signal (CSI-RS), perform one or more CSI measurements based on the CSI-RS, and transmit, based on the DRX cycle, a CSI report including the one or more CSI measurements, where the third signaling includes the CSI report. In some implementations, the UE, the processor, and the method may further be configured to, capable of, or operable to transmit, based on the DRX cycle, a sounding reference signal (SRS). In some implementations, the second signaling is received at a first time, and the UE, the processor, and the method may further be configured to, capable of, or operable to determine one or more offsets in a time domain associated with transmission of the third signaling at a second time after the first time, where the one or more offsets are based on one or more of the first time, the DTX cycle, or the DRX cycle. In some implementations, at least one of the second signaling or the first signaling indicates the one or more offsets. In some implementations, the second signaling includes an indicator that triggers determining the one or more offsets based on an OFF duration (e.g., off duration or period, inactive or non-active duration or period) associated with at least one of the DTX cycle or the DRX cycle.

In some implementations, the UE, the processor, and the method may further be configured to, capable of, or operable to receive, after the second signaling, fourth signaling that indicates a change in a slot format associated with the third signaling, and drop transmission of at least a portion of the third signaling or reception of at least an additional portion of fifth signaling including at least one reference signal based on the change in the slot format. In some implementations, the resource configuration is associated with a maximum latency in a time domain, and the third signaling is transmitted in a resource that satisfies the maximum latency. In some implementations, the second signaling includes at least one of a common activation downlink control information (DCI) received prior to an ON duration (e.g., an on duration or period, an active duration or period) of the DTX cycle or an ON duration of the DRX cycle or a dedicated DCI received during the ON duration of the DTX cycle, and the common activation DCI and the dedicated DCI include at least one field that indicates one or more of a first resource configuration of the set of one or more resource configurations corresponding to a first reference signal or a second resource configuration of the set of one or more resource configurations corresponding to a second reference signal. In some implementations, the first signaling includes radio resource control (RRC) signaling, and respective time domain resource allocation (TDRA) associated with the resource configurations of the set of one or more resource configurations are based on the respective DTX cycles and the DRX cycles.

An NE (e.g., a base station) for wireless communication is described. The NE may be configured to, capable of, or operable to perform one or more operations as described herein. For example, the NE may be configured to, capable of, or operable to transmit first signaling that indicates a set of one or more resource configurations, where resource configurations of the set of one or more resource configurations are associated with respective DTX cycles and DRX cycles corresponding to the NE, transmit second signaling that indicates a resource configuration of the set of one or more resource configurations and that indicates a DTX cycle and a DRX cycle of the respective DTX cycles and the DRX cycles, and receive third signaling based on the resource configuration and at least one of the DTX cycle or the DRX cycle.

A processor (e.g., a standalone processor chipset, or a component of an NE) for wireless communication is described. The processor may be configured to, capable of, or operable to perform one or more operations as described herein. For example, the processor may be configured to, capable of, or operable to transmit first signaling that indicates a set of one or more resource configurations, where resource configurations of the set of one or more resource configurations are associated with respective DTX cycles and DRX cycles corresponding to the NE, transmit second signaling that indicates a resource configuration of the set of one or more resource configurations and that indicates a DTX cycle and a DRX cycle of the respective DTX cycles and the DRX cycles, and receive third signaling based on the resource configuration and at least one of the DTX cycle or the DRX cycle.

A method performed or performable by an NE (e.g., a base station) for wireless communication is described. The method may include transmitting first signaling that indicates a set of one or more resource configurations, where resource configurations of the set of one or more resource configurations are associated with respective DTX cycles and DRX cycles corresponding to the NE, transmitting second signaling that indicates a resource configuration of the set of one or more resource configurations and that indicates a DTX cycle and a DRX cycle of the respective DTX cycles and the DRX cycles, and receiving third signaling based on the resource configuration and at least one of the DTX cycle or the DRX cycle.

In some implementations of the NE, the processor, and the method described herein, the NE, the processor, and the method may further be configured to, capable of, or operable to transmit, based on the DTX cycle, a CSI-RS, and receive, based on the DRX cycle and the CSI-RS, a CSI report including one or more CSI measurements, where the third signaling includes the CSI report. In some implementations, the NE, the processor, and the method may further be configured to, capable of, or operable to receive, based on the DRX cycle, an SRS. In some implementations, the second signaling is received at a first time, and the NE, the processor, and the method may further be configured to, capable of, or operable to determine one or more offsets in a time domain associated with reception of the third signaling at a second time after the first time, where the one or more offsets are based on one or more of the first time, the DTX cycle, or the DRX cycle. In some implementations, at least one of the second signaling or the first signaling indicates the one or more offsets. In some implementations, the second signaling includes an indicator that triggers a UE to determine the one or more offsets based on an OFF duration (e.g., off duration or period, non-active duration or period) associated with at least one of the DTX cycle or the DRX cycle.

In some implementations, the NE, the processor, and the method may further be configured to, capable of, or operable to transmit, after the second signaling, fourth signaling that indicates a change in a slot format associated with the third signaling, and drop reception of at least a portion of the third signaling or transmission of at least an additional portion of fifth signaling including at least one reference signal based on the change in the slot format. In some implementations, the resource configuration is associated with a maximum latency in a time domain, and the third signaling is received in a resource that satisfies the maximum latency. In some implementations, the second signaling includes at least one of a common activation DCI transmitted prior to an ON duration (e.g., on duration or period, active duration or period) of the DTX cycle or an ON duration of the DRX cycle or a dedicated DCI transmitted during the ON duration of the DTX cycle, and the common activation DCI and the dedicated DCI include at least one field that indicates one or more of a first resource configuration of the set of one or more resource configurations corresponding to a first reference signal or a second resource configuration of the set of one or more resource configurations corresponding to a second reference signal. In some implementations, the first signaling includes RRC signaling, and respective TDRA associated with the resource configurations of the set of one or more resource configurations are based on the respective DTX cycles and the DRX cycles.

### BRIEF DESCRIPTION OF THE DRAWINGS

FIG. 1 illustrate an example of a wireless communications system in accordance with aspects of the present disclosure.

FIG. 2 illustrate an example of a transmission diagram in accordance with aspects of the present disclosure.

FIGS. 3 and 4 illustrate examples of wireless communications systems, in accordance with aspects of the present disclosure.

FIG. 5 illustrates an example of a signaling diagram, in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of an NE in accordance with aspects of the present disclosure.

FIG. 9 illustrates a flowchart of a method performed by a UE in accordance with aspects of the present disclosure.

FIG. 10 illustrates a flowchart of a method performed by an NE in accordance with aspects of the present disclosure.

### DETAILED DESCRIPTION

In a wireless communications system, a UE and an NE (e.g., a base station, a gNB) may support transmission and reception of signaling, referred to as wireless communication. For example, the signaling may include reference signals, which the UE and the NE may use for channel estimation, measurement, and feedback, among other examples. A UE may transmit one or more SRSs to an NE to enable uplink channel quality measurements at the NE. The NE may transmit one or more CSI-RSs to the UE to enable downlink channel quality measurements at the UE, and the UE may respond with a CSI report that indicates the measurements.

In some cases, the UE and the NE may implement a pattern (e.g., schedule, scheme, configuration) for transmission and/or reception to reduce power consumption of the UE and the NE, such as DTX cycles and/or DRX cycles. For example, the UE and/or the NE may transmit during one or more ON durations (e.g., an on duration or period, an active duration or period) of a DTX cycle and may refrain from transmitting (e.g., skip transmission, suspend transmission) during one or more OFF durations (e.g., an off duration or period, an non-active duration or period) of the DTX cycle. Additionally, or alternatively, the UE and/or the NE may receive during one or more ON durations of a DRX cycle and may not monitor (e.g., suspend or skip monitoring, listening, detecting) for transmission reception during one or more OFF durations of the DRX cycle. An NE may reduce power consumption by periodically suspending (e.g., muting or deactivating) transmission and reception according to the DTX cycle and the DRX cycle, respectively, such as when a numerical quantity of UEs served by the NE satisfies a threshold. As used herein, “satisfies a threshold” may refer to a value being greater than the threshold, greater than or equal to the threshold, less than the threshold, less than or equal to the threshold, equal to the threshold, not equal to the threshold, or the like. During the OFF duration of the DTX and DRX cycles, the NE may be unable to receive (e.g., does not receive) SRSs from UEs, transmit CSI-RSs, or receive corresponding CSI reports. If the NE fails to receive new or updated SRSs or CSI reports prior to each ON duration of a DTX or DRX cycle, then the NE may lack accurate CSI, which may result in inefficient resource allocation, reduced throughput, or degraded link performance when the NE resumes transmission and/or reception.

As described herein, to improve resource allocation, throughput, and link performance, an NE may transmit signaling to a UE that activates (e.g., enables) a resource configuration for transmission and/or reception of reference signals and CSI reports that align with ON durations of DTX and/or DRX cycles at the NE. For example, the NE may transmit signaling, including RRC signaling or other control signaling, to a UE that establishes a set of resource configurations. The resource configurations may align with different DTX cycles and/or DRX cycles of the NE. The NE may transmit additional signaling, such as a DCI or other control signaling, that activates a resource configuration from the set of resource configurations and that also indicates a DTX cycle and/or DRX cycle that the NE implements. The UE uses the resource configuration and timing information from the DTX and DRX cycles to coordinate transmissions and receptions during ON durations of the DRX cycle and the DTX cycles, respectively. For example, the UE receives CSI-RSs during periods (e.g., a time, duration) when the NE is transmitting according to the DTX cycle of the NE, performs channel quality measurements on the CSI-RSs, and then transmits CSI reports during periods that align with the DRX cycle of the NE when the NE is monitoring for uplink transmissions. Additionally, or alternatively, the UE may transmit SRSs during periods that align with the DRX cycle of the NE, enabling the NE to obtain uplink channel quality measurements to use for scheduling and resource allocation when the NE resumes transmission.

By performing the described techniques, a device (e.g., a UE and/or an NE) in a wireless communications system can provide for improved resource allocation, throughput, and link performance during DRX and DTX operation. For example, an NE can configure a UE with resource configurations that align with DTX and DRX cycles of the NE, enabling the UE to transmit reference signals and CSI reports during periods when the NE is monitoring for uplink transmissions (e.g., ON durations of a DRX cycle) and to receive reference signals during periods when the NE is transmitting (e.g., ON durations of a DTX cycle). The UE may achieve improved CSI accuracy through coordinated timing, where transmission and reception of reference signals and CSI reports occur during ON durations of DRX and DTX cycles, ensuring that the NE obtains updated channel quality measurements prior to or shortly after resuming transmission and reception during the ON durations.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

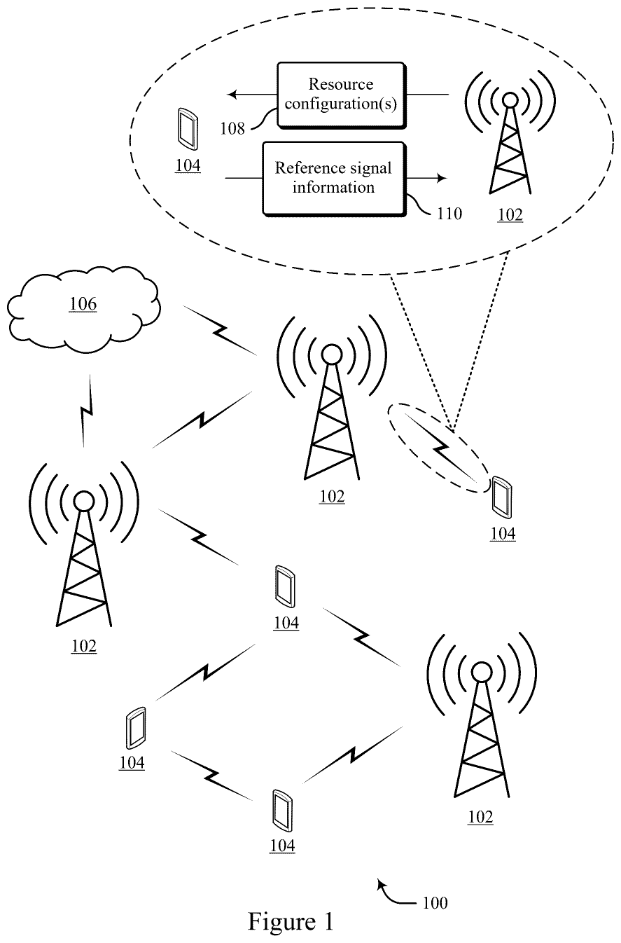

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station (STA), a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In some cases, an NE 102 and/or a UE 104 may implement a DRX cycle and/or a DTX cycle with active periods (e.g., ON durations or periods) and non-active periods (e.g., OFF durations or periods, inactive or non-active durations or periods). For example, the NE 102 implements the DRX cycle and/or the DTX cycle for time domain network energy saving (NES) that provides for an NE 102 (e.g., a base station, a gNB) to reduce power consumption by periodically suspending transmission and/or reception activities, for example if there are a threshold numerical quantity (e.g., a value being greater than a threshold, greater than or equal to the threshold, less than the threshold, less than or equal to the threshold, equal to the threshold, not equal to the threshold, or the like) of active users, such as UEs 104. A DTX cycle for an NE 102 defines one or more periods when the NE 102 refrains from transmitting signals, including downlink data transmissions and reference signals. A DRX cycle for an NE 102 defines one or more periods when the NE 102 does not monitor for or receive uplink transmissions from UEs 104. Each DTX cycle and DRX cycle includes an ON duration (e.g., on duration or period, active duration or period) during which the NE 102 performs transmission or reception activities, and an OFF duration (e.g., off duration or period, non-active duration or period) during which the NE 102 suspends the respective transmission or reception activities.

In some examples, the NE 102 may support one or more DTX cycles and/or DRX cycles, referred to as cell DTX cycles, cell DRX cycles, DTX cycles for an NE 102, and/or DRX cycles for an NE 102. The NE 102 may transmit signaling to one or more UEs 104 that indicates the DTX cycles and the DRX cycles supported by the NE 102. For example, the NE 102 may transmit RRC signaling that indicates the DTX cycles and DRX cycles supported by the NE 102. The signaling may include one or more parameters (e.g., fields, indicators) of respective DTX cycles and/or DRX cycles, such as starting time, slot offset, ON duration time, and/or periodicity. The NE 102 may transmit additional signaling (e.g., a UE-group common DCI 2_9) to activate or deactivate the DTX cycle and/or the DRX cycle. The DCI format 2_9 is used for activating or deactivating cell DTX cycle and/or DRX cycle configurations for one or more serving cells across one or more UEs 104, and for providing an NES-mode indication of a primary cell. The DCI format 2_9 is transmitted with cyclic redundance check (CRC) bits scrambled by a radio network temporary identifier (RNTI) (e.g., cellDTDRX-RNTI) and includes block configurations, where each block is associated with a serving cell. The starting time indicates when a DTX and/or DRX cycle begins in a time domain, the slot offset specifies a delay from a reference point, the on-duration determines how long the ON duration lasts, and the periodicity establishes how frequently the DTX cycle and/or DRX cycle repeats. The NE 102 may configure the DTX cycle and the DRX cycle independently or concurrently (e.g., in a same signal or message). Additionally, or alternatively, the NE 102 may establish multiple DTX cycles and/or DRX cycles for different operational scenarios or traffic patterns.

In some cases, a UE 104 and/or an NE 102 may transmit one or more signals during OFF durations of DTX and/or DRX cycles (e.g., SSBs, DCI formats 2_6 and/or 2_7, DCI for a random access response (RAR) and/or RAR window, DCI for a Msg4 and/or contention resolution timer, and/or positioning signals). However, the UE 104 and/or the NE 102 may not transmit some other signals, such as SRSs and CSI-RSs, during the OFF durations. A UE 104 may transmit one or more SRSs, which are uplink reference signals, to enable NEs 102 to perform uplink channel quality measurements and estimation. A configuration for the SRSs, referred to as an SRS configuration, is defined by an SRS-Config information element (IE), which includes one or more parameters (e.g., srs-ResourceSetToReleaseList, srs-ResourceSetToAddModList, srs-ResourceToReleaseList, and srs-ResourceToAddModList parameters). Each SRS resource set may include one or more SRS resources configured with different transmission parameters, such as frequency domain allocation, time domain allocation, and antenna port configurations. The UE 104 may transmit the SRSs periodically, semi-persistently, or aperiodically based on configuration and triggering by an NE 102. The NE 102 may use the SRSs for uplink scheduling, link adaptation, and beamforming. An NE 102 may transmit one or more CSI-RSs, which are downlink reference signals, to enable UEs 104 to perform downlink channel quality measurements. The NE 102 may transmit the CSI-RSs periodically, semi-persistently, or aperiodically. The UEs 104 may perform one or more measurements and report the measurements in a CSI report to the NE 102. The reference signals enable NEs 102 and UEs 104 to obtain CSI (e.g., reference signal received power (RSRP), signal-to-interference-plus-noise ratio (SINR), channel quality indicator (CQI), rank indicator (RI), and precoding matrix indicator (PMI), among other examples) for performing link adaptation, precoding, scheduling, and/or resource allocation.

However, in some examples, the NE 102 may not receive a CSI report at the beginning of an ON duration, which impacts the ability of the NE 102 to perform efficient link adaptation and precoding. For example, during the OFF duration of the DTX and DRX cycles, the NE 102 may be unable to receive SRSs from UEs 104, transmit CSI-RSs, or receive corresponding CSI reports. If the NE 102 fails to receive new or updated SRSs or CSI reports prior to each ON duration of a DTX or DRX cycle, then the NE 102 may lack accurate CSI, which may result in inefficient resource allocation, reduced throughput, or degraded link performance when the NE 102 resumes transmission and/or reception. Without timely CSI measurements, the NE 102 may be unable to select modulation and coding schemes (MCSs), determine precoding matrices, or allocate resources to maximize spectral efficiency and maintain quality of service for the UEs 104.

According to implementations, one or more of the NEs 102 and the UEs 104 are operable to implement various aspects of the techniques described with reference to the present disclosure. In some examples, an NE 102 and a UE 104 may implement SRS, CSI-RS, and/or CSI reporting configurations to enable the NE 102 to obtain (e.g., receive, acquire) CSI at the beginning of ON durations. For example, an NE 102 (e.g., a base station, gNB) transmits signaling to configure a UE 104 with a set of one or more resource configurations 108 that are associated with respective DTX and DRX cycles of the NE 102. The NE 102 then transmits signaling that activates a resource configuration from the set and indicates corresponding DTX and DRX cycles. In response, the UE 104 may receive one or more CSI-RSs during ON durations of the DTX cycle when the NE 102 is transmitting, perform channel measurements, and/or transmit reference signal information 110 (e.g., CSI reports and/or SRSs) during ON durations of the DRX cycle when the NE 102 is monitoring for uplink transmissions.

As used herein, the term “ON duration” (e.g., also referred to as “on duration,” “active duration,” or “active period”) refers to a time period during which a device (e.g., a UE 104 or an NE 102) actively transmits or receives signals according to a DTX cycle or a DRX cycle. For example, during an ON duration of a DTX cycle, a device may actively transmit downlink or uplink signals, and during an ON duration of a DRX cycle, a device may actively monitor for and receive transmissions. The term “OFF duration” (also referred to as “off duration,” “inactive duration,” “non-active duration,” or “non-active period”) refers to a time period during which a device refrains from transmitting (e.g., in a DTX cycle) or monitoring for reception (e.g., in a DRX cycle) to conserve power. During OFF durations, transmission and/or reception activities may be muted, deactivated, or suspended. Muting refers to a state in which a device temporarily ceases transmission or reception activities to conserve power or reduce interference.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

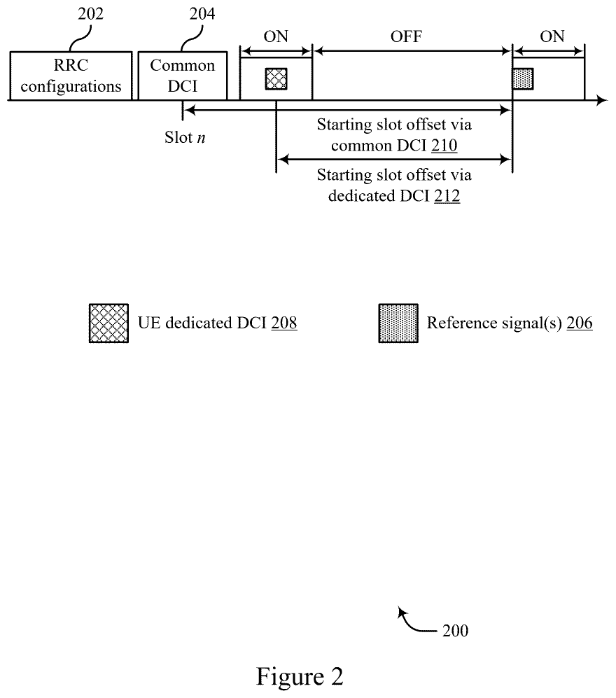

FIG. 2 illustrates an example of a transmission diagram 200 in accordance with aspects of the present disclosure. In some examples, the transmission diagram 200 implements or is implemented by aspects of the wireless communications system 100. For example, the transmission diagram 200 may be implemented by one or more UEs and/or NEs, which may be an example of NEs 102 and UEs 104 as described with reference to FIG. 1. The transmission diagram 200 illustrates an example of resource configuration coordination with DTX and DRX cycles, where an NE may configure a UE with resource configurations that align reference signal transmissions and receptions with ON durations of the DTX and DRX cycles of the NE to enable early and accurate CSI acquisition.

In wireless communications systems, an NE (e.g., base station or gNB) may implement DTX and DRX cycles to reduce power consumption during periods of reduced or low activity. A cell, which represents the coverage area served by an NE, operates according to the DTX and DRX configurations established by the NE. The NE may preconfigure or otherwise define multiple DTX and DRX cycle configurations for a cell or for a carrier to accommodate different operational scenarios and traffic patterns. A carrier may refer to a frequency within a frequency band, where an NE and/or a UE may use the carrier to exchange (e.g., transmit, receive, communicate) information. The DTX and DRX cycle configurations implemented by the NE serve as time domain NES mechanisms that provide for the NE to reduce a power consumption by periodically muting or deactivating transmission and/or reception activities, such as when there are no or minimum active UEs 104 (e.g., less than a threshold numerical quantity, number, or amount of active UEs 104). The NE may use UE-group common DCI 2_9 or other control signaling to activate or deactivate the DTX and DRX cycle configurations.

In some examples, an NE may configure a cell or carrier with one or more DTX cycle and/or DRX cycle configurations that define different operational states. The DTX cycle and/or DRX cycle configurations may include cell active transmission and reception periods, where both downlink and uplink activities occur simultaneously. Additionally, or alternatively, the DTX cycle and/or DRX cycle configurations may include cell active reception periods, where the NE monitors for uplink transmissions but refrains from downlink transmissions. Additionally, or alternatively, the DTX cycle and/or DRX cycle configurations may include cell active transmission periods, where the NE transmits downlink signals but does not monitor for uplink transmissions. Additionally, or alternatively, the DTX cycle and/or DRX cycle configurations may include cell non-active transmission and reception periods, where both transmission and reception activities are suspended. The cell active transmission periods may be referred to as ON durations of a DTX cycle, and the cell active reception periods may be referred to as ON durations of a DRX cycle. The non-active periods may be referred to as OFF durations of the respective DTX or DRX cycles. One or more configuration parameters define the DTX and/or DRX cycles, including one or more starting time parameters that indicate when a DTX and/or a DRX cycle begins, one or more slot offset parameters that indicate a delay from a reference point, one or more on-duration parameters that indicate how long the active period lasts, and/or one or more periodicity parameters that indicate how frequently the cycles repeat.

In some examples, an NE may communicate with one or more UEs according to the DTX cycle and/or the DRX cycle by coordinating transmission and reception activities to align with ON durations of the respective cycles. During ON durations of the DTX cycle, the NE may transmit downlink signals, including control information, data, and reference signals, to the UEs. During ON durations of the DRX cycle, the NE may monitor for and receive uplink transmissions from the UEs, including uplink data, control information, and reference signals. The NE may indicate the DTX and DRX cycles that the NE is using to the UEs to enable the UEs to coordinate transmission and reception activities. The NE may transmit signaling that indicates the DTX and DRX cycle configurations, including the configuration parameters (e.g., starting time, slot offset, ON duration time, and/or periodicity). In some cases, the NE may transmit RRC signaling that indicates one or more DTX cycle and/or DRX cycle configurations, and may transmit activation signaling (e.g., UE-group common DCI 2_9 or other control signaling) that activates a DTX and/or a DRX cycle configuration from the indicated DTX cycle and/or DRX cycle configurations. The activation signaling may indicate which of the DTX cycle and/or DRX cycle configurations is currently active, enabling the UEs to determine when the NE is transmitting downlink transmissions and when the NE is monitoring for uplink transmissions.

The NE may indicate one or more SRSs, CSI-RSs, and/or CSI reporting resources or resource sets to a UE via control signaling, including RRC signaling or other control signaling (e.g., higher layer signaling). A resource set may include one or more SRS, CSI-RS, and/or CSI reporting resources. For example, an SRS resource set may include one or more SRS resources configured with different transmission parameters, such as frequency domain allocation, time domain allocation, and/or antenna port configurations. A CSI-RS resource set may include one or more CSI-RS resources configured with different resource element (RE) patterns, transmission periodicities, and/or beam configurations for channel measurement. A CSI reporting resource set may include multiple CSI report configurations with different reporting periodicities, measurement quantities (e.g., CQI, PMI, RI), and/or codebook configurations. The NE may configure the resources and/or resource sets via RRC signaling, such as part of the RRC configurations 202. In some examples, an SRS, CSI-RS, and/or CSI reporting configuration (e.g., the resources and/or resource sets for the SRS, CSI-RS, and/or CSI reporting in the RRC configurations 202) is associated with a cell DTX and DRX cycle configuration pattern. For example, the resources and/or resource sets in the RRC configurations 202 may have TDRA patterns that account for the DTX and DRX cycle timing at an NE to enable coordination with ON durations and OFF durations at the NE.

A TDRA may include an allocation of time domain resources for transmission or reception of signals in a wireless communications system. The TDRA may indicate when a transmission or reception occurs within a time domain structure, such as within symbols, slots, or subframes, which are units in the time domain. In some examples, a TDRA pattern of a resource or resource set may define a timing of SRS transmissions, CSI-RS receptions, and/or CSI report transmissions relative to DTX and DRX cycle timing. For example, a TDRA pattern may indicate that an SRS resource is transmitted in a first slot of an ON duration of a DRX cycle, or that a CSI-RS resource is received during a second slot of an ON duration of a DTX cycle. The TDRA may include parameters, such as a slot offset, a symbol offset within a slot, a duration in symbols or slots, and/or a periodicity, that defines how frequently the resource allocation repeats. In some examples, the resources and/or resource sets in the RRC configurations 202 may be associated with different TDRA patterns based on the DTX and DRX cycle configurations. For example, a first SRS resource set may be configured with a first TDRA pattern that aligns SRS transmissions with ON durations of a first DRX cycle, where the TDRA pattern indicates transmission in a first available uplink slot following a slot offset from a start of the ON duration. A second SRS resource set may be configured with a second TDRA pattern that aligns SRS transmissions with ON durations of a second DRX cycle, where the TDRA pattern indicates transmission in a third slot of the ON duration. Additionally, or alternatively, a CSI-RS resource set may be configured with a TDRA pattern that schedules CSI-RS transmissions during one or more symbols of slots that fall within ON durations of a DTX cycle. A CSI reporting resource set may be configured with a TDRA pattern that schedules CSI report transmissions to occur a fixed number of slots after CSI-RS reception, where the fixed number of slots is selected, such that the CSI report transmission occurs during an ON duration of a DRX cycle. The association between resources or resource sets and TDRA patterns may enable the NE to coordinate reference signal transmissions and measurements with the timing of DTX and DRX cycles, ensuring that transmissions and receptions occur during ON durations of the DTX and DRX cycles.

In some cases, a UE may receive a common DCI 204 (e.g., a UE common activation DCI) that activates a DTX cycle and/or DRX cycle configuration implemented by an NE. The common DCI 204 may include a triggering indicator (e.g., a CSI request field, trigger field, or activation field) that triggers one or more reference signals 206, such as an SRS resource for one or more SRSs and/or a CSI reporting configurations resource for one or more CSI-RSs and a corresponding CSI report. The NE may transmit the common DCI 204 to one or more UEs (e.g., any numerical quantity of UEs) to activate resource configurations and coordinate timing with DTX and DRX cycles. The NE may transmit the common DCI 204 prior to an ON duration of the DTX cycle or an ON duration of the DRX cycle, and may include at least one field that indicates one or more resource configurations corresponding to different reference signals (e.g., SRSs and/or CSI-RSs with corresponding CSI reports). In some other cases, the UE may receive a UE dedicated DCI 208 (e.g., also referred to as UE specific DCI or individual DCI) from an NE during an ON duration of a DTX cycle of an NE. The UE dedicated DCI 208 provides activation and timing information for the UE during ON durations of the DTX cycle of the NE. The UE dedicated DCI 208 may include at least one field that indicates resource configurations corresponding to the reference signals 206 (e.g., SRSs and/or CSI-RSs with corresponding CSI reports).

Dedicated DCI may be transmitted to a defined UE or a defined group of UEs, where the dedicated DCI is intended for reception by the defined UE or the defined group of UEs. The dedicated DCI may be transmitted during an ON duration of a discontinuous transmission cycle or a discontinuous reception cycle to provide control information for scheduling, resource allocation, or configuration updates. In some examples, the dedicated DCI may include DCI format 1_0, DCI format 1_1, DCI format 1_2, DCI format 0_0, DCI format 0_1, and/or DCI format 0_2, among other formats. The dedicated DCI may be scrambled with a cell-RNTI (C-RNTI), a configured scheduling-RNTI (CS-RNTI), or another UE-specific identifier to enable the defined UE to identify and decode the control information. Common DCI may be transmitted to multiple UEs within a cell or a group of cells, where the common DCI is intended for reception by the multiple UEs, rather than a defined UE. The common DCI may be transmitted prior to an ON duration of a discontinuous transmission cycle or a discontinuous reception cycle to provide control information for system-level configurations, slot format indications, power control commands, or other signaling. In some examples, the common DCI may include DCI format 2_0, DCI format 2_1, DCI format 2_2, DCI format 2_3, DCI format 2_4, DCI format 2_5, or DCI format 2_9, among other formats. The common DCI may be scrambled with a slot format indicator (SFI)-RNTI or another group-common identifier to enable the multiple UEs to identify and decode the control information.

In some cases, the UE may transmit and/or receive the reference signals 206 and/or information related to the reference signals 206 (e.g., a CSI report) based on the resource configurations. For example, the UE may determine one or more offsets to apply to a transmission in the time domain. The offsets may include one or more timing adjustments in a time domain. For example, kᵤ may refer to a UE specific or dedicated slot offset for timing adjustment that accounts for UE specific processing delays or timing criterion. The parameter k_{c} may refer to a common slot offset applicable to multiple UEs or a cell-level offset that accounts for cell DTX and DRX cycle timing, including OFF durations. The parameter kₛ may refer to a time shift or scheduling offset between CSI-RS reception and CSI report transmission that is configured within a CSI reporting configuration.

The DCI (e.g., the common DCI 204 and/or the UE dedicated DCI 208) may trigger an SRS resource for one or more SRSs at slot n, where slot n represents the triggering slot or activation slot. A UE with a UE identifier, u, transmits the SRSs in a slot n+kᵤ+k_{c} that is within an ON duration of a DRX cycle (e.g., a first slot of an ON duration or active reception period), where k_{c} is a slot offset that accounts for timing coordination between the DCI transmission and the SRS resource during active periods of DTX cycles and/or DRX cycles. In some examples, the NE may provide k_{c} via the common DCI 204, where k_{c} is a common slot offset applicable to one or more triggered UEs. In some other examples, the NE may provide k_{c} via the UE dedicated DCI 208, where k_{c} is a dedicated slot offset for a defined UE. The NE and/or the UE may select (e.g., identify, determine) k_{c} to account for the ON and OFF durations of DTX and/or DRX cycles of the NE, such that transmissions occur during ON duration periods of the DTX and DRX cycles. For example, the UE transmits the SRSs (e.g., the reference signals 206) in a slot that is based on the starting slot offset via common DCI 210 or the starting slot offset via dedicated DCI 212, which accounts for the OFF duration between the triggering slot and the actual transmission slot.

Additionally, or alternatively, the DCI may trigger a CSI reporting resource for one or more CSI-RSs and a corresponding CSI report at a slot n. A UE with a UE identifier, u, may receive the CSI-RSs (e.g., the reference signals 206) in a slot n+kᵤ+k_{c} that is within an ON duration of a DTX cycle of an NE (e.g., also referred to as a downlink active period or DTX ON duration) and transmit the CSI report in a slot n+kᵤ+k_{c}+kₛ that is within an ON duration of a DRX cycle of the NE (e.g., also referred to as uplink active period or DRX ON duration). In some cases, the parameter kₛ is a time shift (e.g., also referred to as time offset, delay parameter, or scheduling offset) configured within the triggered CSI reporting configuration. The parameter kₛ may be an example of a UE resource dedicated offset or a timing parameter for a UE. The UE receives the CSI-RSs during periods when the NE is transmitting according to an ON duration of the DTX cycle of the NE, performs channel quality measurements on the CSI-RSs, and then transmits CSI reports during periods that align with an ON duration of the DRX cycle of the NE when the NE is monitoring for uplink transmissions. Additionally, or alternatively, the UE may transmit SRSs during periods that align with the DRX cycle of the NE, enabling the NE to obtain uplink channel quality measurements to use for scheduling and resource allocation when the NE resumes transmission.

In some cases, the DCI (e.g., common DCI 204 or UE dedicated DCI 208) may trigger an SRS resource and a CSI reporting resource jointly or separately using a same triggering indicator or using separate triggering indicators, also referred to as joint activation or independent activation mechanisms. Joint triggering may use a single field or bit pattern to activate both SRS and CSI reporting resources simultaneously. Separate triggering may use distinct fields or indicators for each resource type, providing more granular control over resource activation timing. The DCI may include separate triggering indicators for different types of reference signals, providing for the network (e.g., the NE) to selectively activate SRS resources, CSI-RS resources, and/or CSI reporting resources according to current channel conditions and measurement criterion.

In some examples, kᵤ≥0 is a slot offset (e.g., also referred to as time offset, delay parameter, or scheduling offset) dedicated for a UE with a UE identifier, u. The NE may provide the UE with a value of kᵤ as a dedicated offset provided within a SRS and/or CSI reporting configuration message (e.g., in the RRC configurations 202). Additionally, or alternatively, the NE may provide the UE with a value of kᵤ via the UE dedicated DCI 208 and/or another dedicated triggering DCI, also referred to as a UE specific offset, individual timing parameter, or per-UE scheduling delay. The parameter kᵤ provides for timing adjustments per UE to account for processing delays, propagation delays, or other UE factors that may affect the timing of resource transmissions. The parameter kᵤ enables fine-tuning of transmission timing to accommodate individual UE capabilities and channel conditions, ensuring coordination with the DTX cycle and/or DRX cycle timing. In some cases, k_{c}≥0 is a common slot offset (e.g., also referred to as cell level offset, shared timing parameter, or group offset) for one or more triggered UEs. The NE may transmit the parameter k_{c} (e.g., explicitly) via the RRC configurations 202, the common DCI 204, and/or the UE dedicated DCI 208. The value of k_{c} corresponds to the starting slot offset via common DCI 210 or the starting slot offset via dedicated DCI 212, which accounts for the timing coordination between the DCI transmission and the actual resource usage during active periods of DTX and DRX cycles. For example, the NE may utilize the parameter k_{c} to indicate to the UE when to use resources relative to the DTX and DRX cycle timing, as illustrated by the starting slot offset via common DCI 210 and the starting slot offset via dedicated DCI 212. The NE explicitly configuring the value of k_{c} provides more flexibility to the NE when configuring the starting time of a triggered resource (e.g., to account for the OFF duration gap). The common offset enables synchronized resource usage across multiple UEs when using the common DCI 204, while the dedicated offset provides individual timing control when using UE dedicated DCI 208.

In some cases, the activation or triggering DCI (e.g., the common DCI 204 or the UE dedicated DCI 208) may include a binary indicator, also referred to as a flag, trigger bit, or activation indicator. A first value of the binary indicator (e.g., 1 or 0 depending on the implementation) triggers the UE to implicitly determine an OFF duration of an NE (e.g., k_{c}) using one or more of activated cell DTX and DRX cycle configuration parameters. The OFF duration may also be referred to as an inactive period or duration, non-active period or duration, or a sleep period or duration. The DTX and DRX cycle configuration parameters may include, but are not limited to, one or more cycle length parameters, one or more ON duration parameters, one or more OFF duration parameters, one or more periodicity parameters, and/or one or more starting time parameters. The UE may utilize the determined OFF duration to determine a triggered resource starting slot determination (e.g., as slot n+kᵤ+k_{c}). The implicit determination mechanism provides for the UE to automatically calculate a timing offset utilizing current DTX cycle and/or DRX cycle states that bridges an OFF duration gap to ensure resource transmission occurs during a subsequent ON duration. The implicit approach reduces signaling overhead by using a binary indicator to trigger the UE to calculate the off duration time and add the off duration time to the resource starting slot determination, leveraging the activated DTX cycle and/or DRX cycle configuration parameters to determine the timing without explicit offset values in the DCI. A UE may determine k_{c}=0 (e.g., no additional common offset), if a value of k_{c} is not provided or indicated. For example, the NE may not provide a value for k_{c} if kᵤ (e.g., the UE specific offset) is sufficient to account for an OFF duration of a DTX cycle and/or DRX cycle of the NE.

In some examples, a UE may receive a DCI or other control signaling that indicates a change in a configured slot format (e.g., slot structure, time domain format, or resource allocation pattern) outside of an ON duration of a DTX cycle and/or DRX cycle of an NE (e.g., during an OFF duration, inactive period, or non-active time). As used herein, a slot format refers to a configuration that defines the direction of transmission (e.g., uplink, downlink, or flexible) for symbols within a slot in a time domain structure. A slot format may indicate which symbols in a slot are designated (e.g., assigned, allocated, scheduled) for uplink transmission, downlink transmission, or flexible use, and may be dynamically changed via control signaling. The slot format change may be indicated through DCI format 2_0, which is used for notifying slot format, channel occupancy time (COT) duration, available resource block (RB) set, and search space set group switching. DCI format 2_0 includes slot format indicators, available RB set indicators, COT duration indicators, and search space set group switching flags, with the size of DCI format 2_0 being configurable by higher layers up to 128 bits. If the UE has received a DCI triggering an SRS and/or CSI reporting resource (e.g., the common DCI 204 or the UE dedicated DCI 208) prior to the change in the configured slot format, then the UE may drop (e.g., cancel, skip) a triggered SRS and/or CSI reporting resource if the starting slot of the triggered SRS and/or CSI reporting resource falls within a non-uplink slot (e.g., a downlink slot or unavailable uplink resource). Additionally, or alternatively, the UE may drop a CSI-RS reception if the starting slot falls within a non-downlink slot (e.g., an uplink slot or an unavailable downlink resource). The slot format change indication may be provided through DCI format 2_0 or similar control signaling mechanisms that notify UEs of dynamic changes in slot structure during OFF durations.

In some cases, the UE may be configured with a maximum latency associated with an SRS and/or a CSI-RS and reporting resource. The UE may transmit the triggered SRS and/or the CSI report within an earliest available uplink slot within the configured maximum latency. Otherwise, the UE may drop (e.g., cancel, skip) the SRS and/or a CSI-RS and reporting transmission. The maximum latency enables a UE and/or an NE to maintain relevance of reference signal transmissions and CSI reports for CSI purposes, preventing or reducing transmission of outdated measurements. The maximum latency parameter provides a time window within which the triggered resources are transmitted. If uplink slots are not available within the window due to the slot forma, DTX cycle, and/or DRX cycle timing conflicts, then the UE cancels the transmission to reduce or prevent providing stale channel information to the NE.

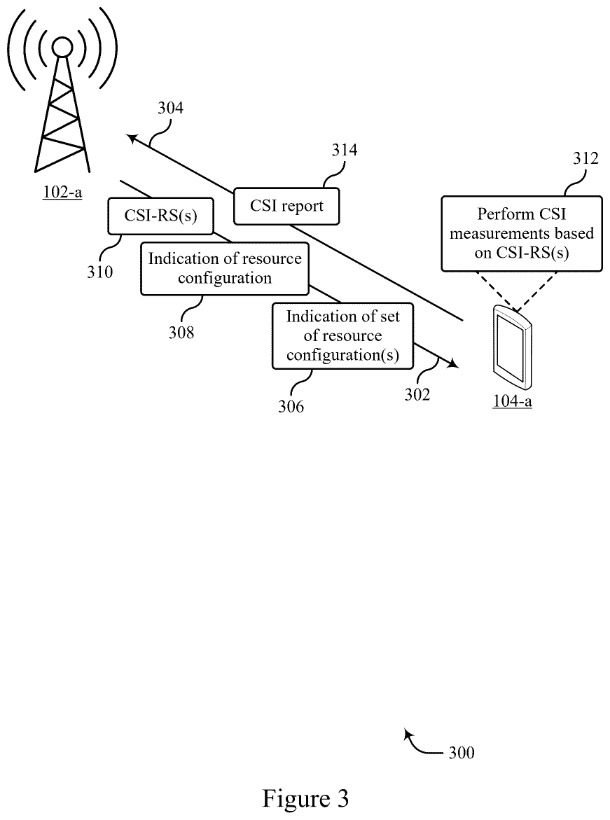

FIG. 3 illustrates an example of a wireless communications system 300 in accordance with aspects of the present disclosure. In some examples, the wireless communications system 300 implements or is implemented by aspects of the wireless communications system 100 and the transmission diagram 200. For example, the wireless communications system 300 may include an NE 102-a and a UE 104-a, which may be examples of an NE 102 and a UE 104, as described with reference to FIG. 1. In some examples, the NE 102-a may transmit signaling (e.g., control signaling and/or data) to the UE 104-a via a downlink wireless communications link 302. Additionally, or alternatively, the UE 104-a may transmit signaling (e.g., control signaling and/or data) to the NE 102-a via an uplink wireless communications link 304. For example, the NE 102-a may configure the UE 104-a with resource configurations that align with DTX cycles and/or DRX cycles of the NE 102-a to enable CSI acquisition at the beginning of ON durations of the DTX cycles and/or the DRX cycles.

The NE 102-a transmits an indication of a set of resource configurations 306 to the UE 104-a via the downlink wireless communications link 302. The set of resource configurations 306 can include any numerical quantity of resource configurations, where each resource configuration corresponds to a DTX cycle and/or a DRX cycle of the NE 102-a. The resource configurations may define timing parameters, resource allocation patterns, and/or other configuration information that enables the UE 104-a to coordinate transmissions and receptions during ON durations of the DTX and DRX cycles of the NE 102-a. In some cases, the NE 102-a may transmit the indication of the set of resource configurations 306 via RRC signaling or other control signaling (e.g., higher layer signaling), establishing the available resource configurations that the UE 104-a can use for reference signal transmission and CSI reporting.

The NE 102-a transmits an indication of a resource configuration 308 to the UE 104-a via the downlink wireless communications link 302. The indication of the resource configuration 308 activates a resource configuration from the set of resource configurations and indicates a DTX cycle and a DRX cycle for that resource configuration. In some cases, the NE 102-a may transmit the indication of the resource configuration 308 via a common activation DCI or a UE dedicated DCI, as described with reference to FIG. 2. The indication of the resource configuration 308 may include timing information, such as the starting time, slot offset, ON duration time, and/or periodicity of a DTX cycle and/or DRX cycle, enabling the UE 104-a to determine when the NE 102-a will be transmitting (e.g., during ON durations of the DTX cycle) and when the NE 102-a will be monitoring for uplink transmissions (e.g., during ON durations of the DRX cycle). The indication of the resource configuration 308 may also include triggering information for SRS resources and/or CSI reporting resources, as well as offset parameters (e.g., kᵤand k_{c}) that determine the timing of reference signal transmissions and CSI report transmissions relative to the DTX and DRX cycles.

After receiving the indication of resource configuration 308, the UE 104-a may receive one or more CSI-RSs 310 from the NE 102-a via the downlink wireless communications link 302. The NE 102-a transmits the CSI-RSs 310 during ON durations of the DTX cycle (e.g., when the NE 102-a is actively transmitting). The UE 104-a may determine timing of the CSI-RSs 310 according to the resource configuration indicated in the indication of the resource configuration 308 and the DTX cycle parameters. The CSI-RSs 310 enable the UE 104-a to perform downlink channel quality measurements, which the UE 104-a uses to generate CSI reports that the NE 102-a uses for link adaptation, precoding, scheduling, and resource allocation.

At 312, the UE 104-a performs CSI measurements based on the received CSI-RSs 310. The CSI measurements may include, but are not limited to, RSRP, SINR, CQI, RI, PMI, or other channel quality metrics. The UE 104-a processes the CSI-RSs 310 to obtain CSI that reflects one or more current downlink channel conditions. The UE 104-a may perform the CSI measurements and transmit a CSI report 314 that indicates the CSI measurements during an ON duration of the DRX cycle (e.g., when the NE 102-a is monitoring for uplink transmissions). For example, the UE 104-a transmits the CSI report 314 to the NE 102-a via the uplink wireless communications link 304. The UE 104-a may determine a timing for transmission of the CSI report 314 utilizing the resource configuration indicated in the indication of the resource configuration 308, the DRX cycle parameters, and one or more offset parameters (e.g., kᵤ, k_{c}, and kₛ) that account for processing time and OFF durations of the DTX and DRX cycles. By coordinating the transmission of the CSI report 314 with the DRX cycle, the NE 102-a receives updated CSI at the beginning of active time periods. The NE 102-a utilizes the CSI to perform link adaptation, precoding, and resource allocation when resuming transmission and reception activities.

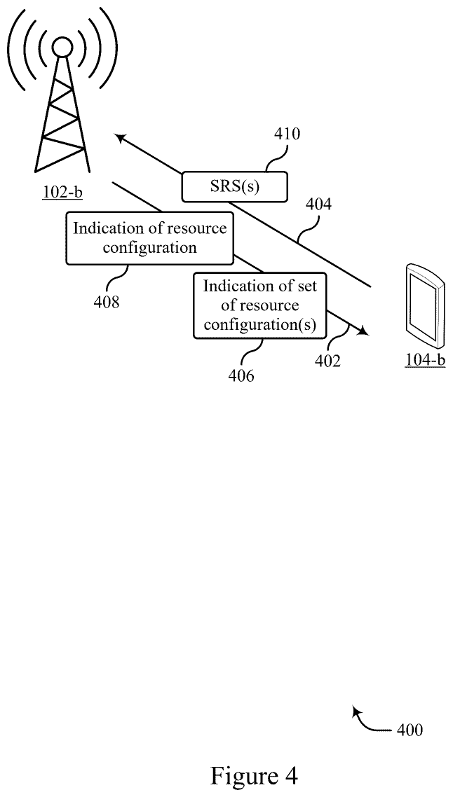

FIG. 4 illustrates an example of a wireless communications system 400 in accordance with aspects of the present disclosure. In some examples, the wireless communications system 400 implements or is implemented by aspects of the wireless communications system 100, the transmission diagram 200, and the wireless communications system 300. For example, the wireless communications system 400 may include an NE 102-b and a UE 104-b, which may be examples of an NE 102 and a UE 104, as described with reference to FIGS. 1 and 3. In some examples, the NE 102-b may transmit signaling (e.g., control signaling and/or data) to the UE 104-b via a downlink wireless communications link 402. Additionally, or alternatively, the UE 104-b may transmit signaling (e.g., control signaling and/or data) to the NE 102-b via an uplink wireless communications link 404. For example, the NE 102-b may configure the UE 104-b with resource configurations that align with DTX and DRX cycles of the NE 102-b to enable uplink channel quality measurements of SRS transmissions at the beginning of ON durations of a DRX cycle of the NE 102-b.

The NE 102-b transmits an indication of a set of resource configurations 406 to the UE 104-b via the downlink wireless communications link 402. The indication of the set of resource configurations 406 can include any numerical quantity of resource configurations, where each resource configuration corresponds to a DTX cycle and/or a DRX cycle of the NE 102-b. The resource configurations may define timing parameters, resource allocation patterns, and/or other configuration information that enables the UE 104-b to coordinate SRS transmissions during ON durations of the DRX cycle when the NE 102-b is actively monitoring for uplink transmissions. In some cases, the NE 102-b may transmit the indication of the set of resource configurations 406 via RRC signaling or other control signaling (e.g., higher layer signaling), establishing the available resource configurations that the UE 104-b can use for SRS transmission.

The NE 102-b transmits an indication of a resource configuration 408 to the UE 104-b via the downlink wireless communications link 402. The indication of the resource configuration 408 activates a resource configuration from the set of resource configurations and indicates a DTX cycle and/or a DRX cycle for the resource configuration. In some cases, the NE 102-b may transmit the indication of the resource configuration 408 via a common activation DCI or a UE dedicated DCI, as described with reference to FIG. 2. The indication of the resource configuration 408 may include timing information, such as the starting time, slot offset, ON duration time, and/or periodicity of a DTX cycle and/or DRX cycle, enabling the UE 104-b to determine when the NE 102-b will be monitoring for uplink transmissions (e.g., during ON durations of the DRX cycle). The indication of resource configuration 408 may also include triggering information for SRS resources, as well as offset parameters (e.g., kᵤand k_{c}) that determine the timing of SRS transmissions relative to the DRX cycle.

After receiving the indication of resource configuration 408, the UE 104-b transmits SRSs 410 to the NE 102-b via the uplink wireless communications link 404. The UE 104-b transmits the SRSs 410 during ON durations of the DRX cycle (e.g., when the NE 102-b is monitoring for uplink transmissions). The UE 104-b may determine timing of the SRSs 410 according to the resource configuration indicated in the indication of the resource configuration 408 and the DRX cycle parameters. The SRSs 410 enable the NE 102-b to perform uplink channel quality measurements, which the NE 102-b uses for uplink scheduling, link adaptation, and beamforming.

The UE 104-b may determine a timing for transmission of the SRSs 410 utilizing the resource configuration indicated in the indication of the resource configuration 408, the DRX cycle parameters, and one or more offset parameters (e.g., kᵤand k_{c}) that account for processing time and OFF durations of the DTX and DRX cycles. By coordinating the transmission of the SRSs 410 with the DRX cycle, the NE 102-b performs updated uplink channel quality measurements at the beginning of active time periods. The NE 102-b utilizes the SRSs 410 to perform uplink scheduling and resource allocation when resuming reception activities.

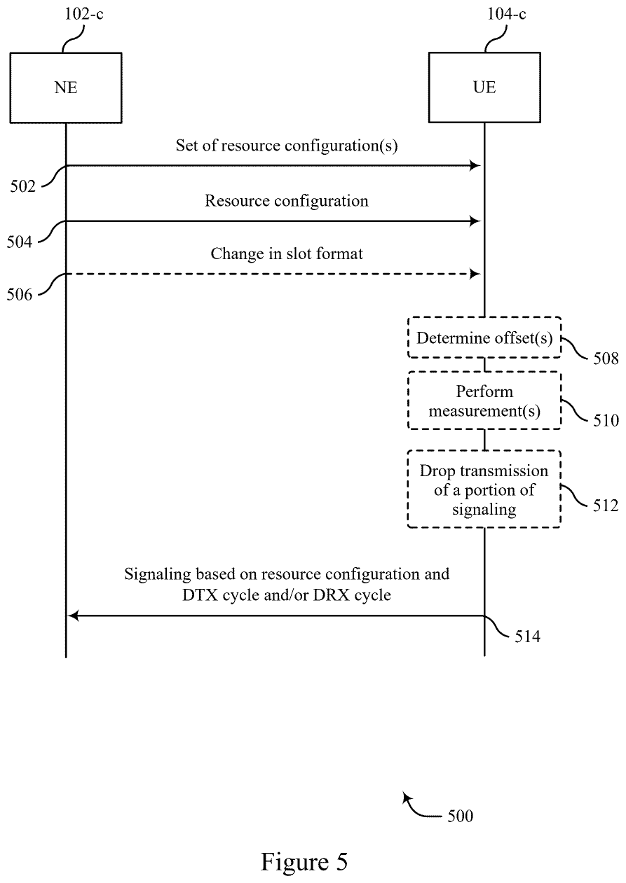

FIG. 5 illustrates an example of a signaling diagram 500 in accordance with aspects of the present disclosure. In some examples, the signaling diagram 500 implements or is implemented by aspects of the wireless communications system 100, the transmission diagram 200, the wireless communications system 300, and the wireless communications system 400. The signaling diagram 500 may implement or be implemented by one or more devices, such as an NE 102-c and a UE 104-c, which may be examples of an NE 102 and a UE 104 as described with reference to FIGS. 1, 3, and 4. The signaling diagram 500 may illustrate an example of resource configuration coordination with DTX and DRX cycles in wireless communications. Alternative examples of the following may be implemented, where some processes are performed in a different order than described or are not performed. In some cases, processes may include additional features not mentioned below, or further processes may be added.

At 502, the NE 102-c transmits a set of one or more resource configurations to the UE 104-c. A resource configuration includes one or more timing parameters that align with ON durations and/or OFF durations of respective DTX cycles and/or DRX cycles of the NE 102-c, such that reference signal transmissions occur when the NE 102-c is transmitting or receiving. The NE 102-c may transmit the set of resource configurations via RRC signaling or other control signaling. The NE 102-c may determine respective TDRAs associated with the resource configurations based on the respective DTX cycles and/or DRX cycles. For example, the NE 102-c may incorporate slot offsets, symbol offsets, and periodicity parameters that correspond to the timing structure of the ON durations and OFF durations of the DTX cycles and/or DRX cycles into the TDRAs. Each resource configuration in the set defines parameters for coordinating reference signal transmissions and CSI reporting with the DTX and DRX cycles of the NE 102-c.

At 504, the NE 102-c transmits a resource configuration to the UE 104-c. For example, the NE 102-c transmits signaling that indicates a resource configuration from the set of resource configurations and that indicates a DTX cycle and/or a DRX cycle. The signaling may include one or more parameters, such as starting time, slot offset, ON duration time, and periodicity values that define when the NE 102-c will be in active transmission or reception states. The NE 102-c may transmit the resource configuration in at least one of a common activation DCI that the UE 104-c receives prior to an ON duration of the DTX cycle or an ON duration of the DRX cycle, or a dedicated DCI that the UE 104-c receives during the ON duration of the DTX cycle. The common activation DCI and the dedicated DCI include at least one field that indicates one or more of a first resource configuration corresponding to a first reference signal or a second resource configuration corresponding to a second reference signal. For example, the UE 104-c and/or the NE 102-c map field values or bit patterns in the DCI to resource configurations that are defined (e.g., preconfigured) for different types of reference signals. The signaling including the resource configuration at 504 may also include an indicator that triggers the UE 104-c to determine one or more offsets based on an OFF duration associated with at least one of the DTX cycle or the DRX cycle. For example, the UE 104-c may determine (e.g., calculate, identify, obtain) timing offsets that account for OFF durations between the DCI reception time and the next available ON duration for transmission or reception at the NE 102-c. Additionally, or alternatively, the signaling including the resource configuration at 504 and/or the set of resource configurations at 502 may indicate the one or more offsets explicitly (e.g., by including the offsets as parameters in the signaling).

In some cases, at 506, the NE 102-c may transmit a change in slot format to the UE 104-c. The slot format change may impact an availability of uplink or downlink resources during the time periods when a reference signal and/or CSI report is scheduled to be transmitted (e.g., based on the resource configuration at 504), potentially causing the UE 104-c to modify or cancel planned transmissions.

In some examples, at step 508, the UE 104-c determines one or more offsets. Since the UE 104-c receives the resource configuration at a first time, the UE 104-c determines the one or more offsets in a time domain for transmission of a reference signal and/or CSI report at a second time after the first time. The UE 104-c bases the one or more offsets on one or more of the first time, the DTX cycle, and/or the DRX cycle by calculating the time difference between the first time and the next available ON duration of the relevant DTX or DRX cycle, accounting for any OFF durations that occur between the first time and the second time. If the signaling including the resource configuration at 504 includes an indicator (e.g., a binary indicator, a flag) that triggers the UE 104-c to implicitly determine the offsets, then the UE 104-c calculates the offsets based on an OFF duration of at least one of the DTX cycle or the DRX cycle of the NE 102-c.

In some cases, at 510, the UE 104-c performs one or more measurements. The UE 104-c may receive a CSI-RS from the NE 102-c during an ON duration of a DTX cycle of the NE 102-c. The UE 104-c performs one or more CSI measurements utilizing the CSI-RS. For example, the UE 104-c monitors for and receives the CSI-RS during one or more ON durations of a DTX cycle of an NE 102-c (e.g., when the NE 102-c is actively transmitting downlink signals). The UE 104-c processes the received CSI-RS to extract one or more channel quality metrics, such as RSRP, SINR, CQI, RI, and/or PMI. The measurements enable the UE 104-c to assess downlink channel quality and prepare CSI reports for transmission to the NE 102-c during timing windows that align with an ON duration of a DRX cycle of the NE 102-c.

In some examples, at 512, the UE 104-c may drop (e.g., cancel, skip) transmission of a portion of signaling (e.g., a reference signal and/or CSI report). If the UE 104-c receives the change in slot format at 506, then the UE 104-c may drop transmission of at least a portion of the signaling or reception of at least an additional portion of signaling including at least one reference signal (e.g., a CSI-RS) according to the change in the slot format. For example, the UE 104-c may determine that one or more originally scheduled transmission or reception slots are no longer configured as uplink or downlink slots, respectively, such that the scheduled signaling operations are incompatible with the new slot structure. The UE 04-c may not attempt to transmit or receive signals in incorrect slot types that the NE 102-c may have reconfigured during the DTX and DRX operation.

At 514, the UE 104-c transmits signaling based on the resource configuration and DTX cycle and/or DRX cycle to the NE 102-c. The UE 104-c uses the timing parameters, frequency allocations, and transmission patterns indicated in the activated resource configuration to transmit the signaling. The UE 104-c may schedule the transmission to occur during ON durations of a DRX cycle of the NE 102-c when the NE 102-c is actively monitoring for uplink transmissions. The signaling may include a CSI report including the one or more CSI measurements that the UE 104-c performed at 510. Additionally or alternatively, the third signaling may include one or more SRSs. The resource configuration may have a maximum latency in a time domain, and the UE 104-c transmits the signaling in a resource that satisfies the maximum latency to. For example, the NE 102-c configures a time window parameter that defines a maximum allowable delay between the triggering event and an actual transmission, and the UE 104-c completes the transmission within the time window or cancels the transmission if the time window expires.

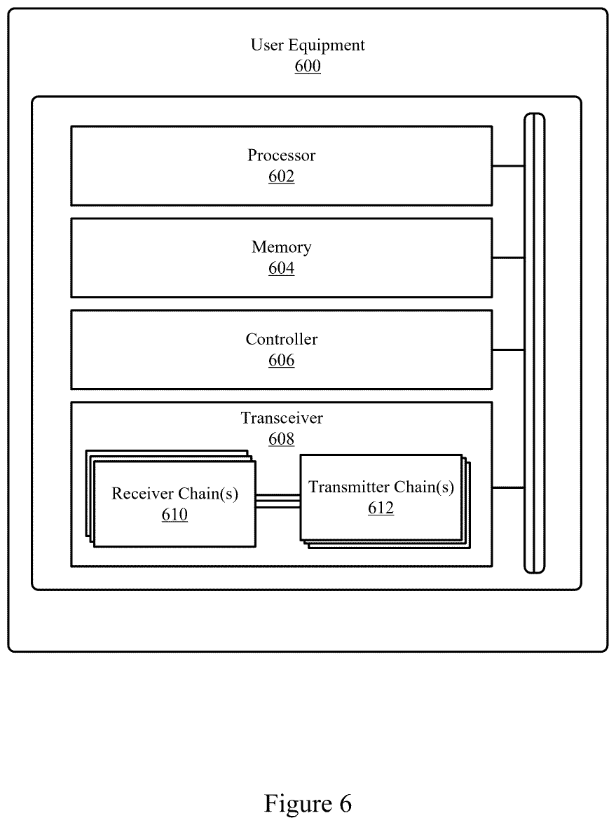

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a central processing unit (CPU), an ASIC, a field-programmable gate-array (FPGA), or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to or operable to support a means for receiving first signaling that indicates a set of one or more resource configurations, where resource configurations of the set of one or more resource configurations are associated with respective DTX cycles and DRX cycles corresponding to an NE, receiving second signaling that indicates a resource configuration of the set of one or more resource configurations and that indicates a DTX cycle and a DRX cycle of the respective DTX cycles and the DRX cycles, and transmitting third signaling based on the resource configuration and at least one of the DTX cycle or the DRX cycle. In this manner, the UE 600 enables coordinated transmission and reception timing that aligns with NES cycles, improving CSI accuracy and reducing power consumption, while maintaining communication efficiency.

Additionally, the UE 600 may be configured to support any one or combination of receiving, based on the DTX cycle, a CSI-RS, performing one or more CSI measurements based on the CSI-RS, and transmitting, based on the DRX cycle, a CSI report including the one or more CSI measurements, where the third signaling includes the CSI report. This aspect ensures that channel measurements are obtained during network transmission periods and reported during network reception periods, providing timely and accurate CSI for improved link adaptation and resource allocation. Additionally, or alternatively, the UE 600 may be configured to or operable to support transmitting, based on the DRX cycle, an SRS. This feature enables uplink channel quality measurements to be transmitted when the network is actively monitoring, facilitating efficient uplink scheduling and beamforming. Additionally, or alternatively, the second signaling is received at a first time, and the UE 600 may be configured to or operable to support determining one or more offsets in a time domain associated with transmission of the third signaling at a second time after the first time, where the one or more offsets are based on one or more of the first time, the DTX cycle, or the DRX cycle. This capability accounts for network inactive periods in transmission timing calculations, ensuring reference signals are transmitted during active periods (e.g., ON durations) for reception. Additionally, or alternatively, the UE 600 may be configured to or operable to support at least one of the second signaling or the first signaling indicates the one or more offsets. The explicit offset indication provides timing control that reduces signaling overhead, while ensuring accurate coordination with network active periods. Additionally, or alternatively, the UE 600 may be configured to or operable to support the second signaling includes an indicator that triggers determining the one or more offsets based on an OFF duration associated with at least one of the DTX cycle or the DRX cycle. The implicit offset determination reduces signaling overhead, while automatically adapting transmission timing to NES patterns.

Additionally, or alternatively, the UE 600 may be configured to or operable to support receiving, after the second signaling, fourth signaling that indicates a change in a slot format associated with the third signaling, and dropping transmission of at least a portion of the third signaling or reception of at least an additional portion of fifth signaling including at least one reference signal based on the change in the slot format. The dynamic adaptation to slot format changes prevents transmission errors and maintains system reliability during network reconfiguration events. Additionally, or alternatively, the UE 600 may be configured to or operable to support the resource configuration is associated with a maximum latency in a time domain, and the third signaling is transmitted in a resource that satisfies the maximum latency. The latency criterion ensures timely delivery of CSI, while accommodating NES cycles, maintaining quality of service criterion. Additionally, or alternatively, the UE 600 may be configured to or operable to support the second signaling includes at least one of a common activation DCI received prior to an ON duration of the DTX cycle or an ON duration of the DRX cycle or a dedicated DCI received during the ON duration of the DTX cycle, and the common activation DCI and the dedicated DCI include at least one field that indicates one or more of a first resource configuration of the set of one or more resource configurations corresponding to a first reference signal or a second resource configuration of the set of one or more resource configurations corresponding to a second reference signal. The flexible activation mechanism enables efficient resource triggering that can accommodate both group and individual device configurations, while coordinating with network active periods. Additionally, or alternatively, the UE 600 may be configured to or operable to support the first signaling includes RRC signaling, and respective TDRA associated with the resource configurations of the set of one or more resource configurations are based on the respective DTX cycles and the DRX cycles. The TDRA alignment with DTX and DRX cycles reduces real-time signaling overhead, while ensuring timing coordination for reference signal transmissions.

Additionally, or alternatively, the UE 600 may support at least one memory (e.g., the memory 604) and at least one processor (e.g., the processor 602) coupled with the at least one memory and configured to or operable to cause the UE to receive first signaling that indicates a set of one or more resource configurations, where resource configurations of the set of one or more resource configurations are associated with respective DTX cycles and DRX cycles corresponding to an NE, receive second signaling that indicates a resource configuration of the set of one or more resource configurations and that indicates a DTX cycle and a DRX cycle of the respective DTX cycles and the DRX cycles, and transmit third signaling based on the resource configuration and at least one of the DTX cycle or the DRX cycle.

Additionally, the UE 600 may be configured to or operable to support any one or combination of to receive, based on the DTX cycle, a CSI-RS, perform one or more CSI measurements based on the CSI-RS, and transmit, based on the DRX cycle, a CSI report including the one or more CSI measurements, where the third signaling includes the CSI report. Additionally, or alternatively, the UE 600 may be configured to or operable to support to transmit, based on the DRX cycle, an SRS. Additionally, or alternatively, the second signaling is received at a first time, and the UE 600 may be configured to or operable to support to determine one or more offsets in a time domain associated with transmission of the third signaling at a second time after the first time, where the one or more offsets are based on one or more of the first time, the DTX cycle, or the DRX cycle. Additionally, or alternatively, the UE 600 may be configured to or operable to support at least one of the second signaling or the first signaling indicates the one or more offsets. Additionally, or alternatively, the UE 600 may be configured to or operable to support the second signaling includes an indicator that triggers determining the one or more offsets based on an OFF duration associated with at least one of the DTX cycle or the DRX cycle.

Additionally, or alternatively, the UE 600 may be configured to or operable to support to receive, after the second signaling, fourth signaling that indicates a change in a slot format associated with the third signaling, and drop transmission of at least a portion of the third signaling or reception of at least an additional portion of fifth signaling including at least one reference signal based on the change in the slot format. Additionally, or alternatively, the UE 600 may be configured to or operable to support the resource configuration is associated with a maximum latency in a time domain, and the third signaling is transmitted in a resource that satisfies the maximum latency. Additionally, or alternatively, the UE 600 may be configured to or operable to support the second signaling includes at least one of a common activation DCI received prior to an ON duration of the DTX cycle or an ON duration of the DRX cycle or a dedicated DCI received during the ON duration of the DTX cycle, and the common activation DCI and the dedicated DCI include at least one field that indicates one or more of a first resource configuration of the set of one or more resource configurations corresponding to a first reference signal or a second resource configuration of the set of one or more resource configurations corresponding to a second reference signal. Additionally, or alternatively, the UE 600 may be configured to or operable to support the first signaling includes RRC signaling, and respective TDRA associated with the resource configurations of the set of one or more resource configurations are based on the respective DTX cycles and the DRX cycles.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

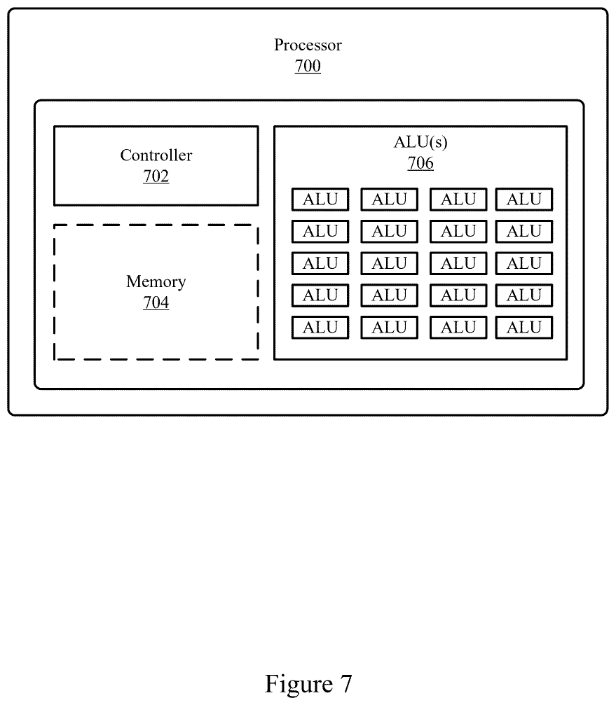

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory addresses of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, ALUs 706, and other functional units of the processor 700.

The memory 704 may include one or more caches (e.g., memory local to or included in the processor 700 or other memory, such as RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, and the controller 702, and may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 may be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to receive first signaling that indicates a set of one or more resource configurations, where resource configurations of the set of one or more resource configurations are associated with respective DTX cycles and DRX cycles corresponding to an NE, receive second signaling that indicates a resource configuration of the set of one or more resource configurations and that indicates a DTX cycle and a DRX cycle of the respective DTX cycles and the DRX cycles, and transmit third signaling based on the resource configuration and at least one of the DTX cycle or the DRX cycle. In this manner, the processor 700 enables coordinated transmission and reception timing that aligns with NES cycles, improving CSI accuracy and reducing power consumption, while maintaining communication efficiency.

Additionally, the processor 700 may be configured to or operable to support any one or combination of to receive, based on the DTX cycle, a CSI-RS, perform one or more CSI measurements based on the CSI-RS, and transmit, based on the DRX cycle, a CSI report including the one or more CSI measurements, where the third signaling includes the CSI report. This aspect ensures that channel measurements are obtained during network transmission periods and reported during network reception periods, providing timely and accurate CSI for improved link adaptation and resource allocation. Additionally, or alternatively, the processor 700 may be configured to or operable to support to transmit, based on the DRX cycle, an SRS. This feature enables uplink channel quality measurements to be transmitted when the network is actively monitoring, facilitating efficient uplink scheduling and beamforming. Additionally, or alternatively, the second signaling is received at a first time, and the processor 700 may be configured to or operable to support to determine one or more offsets in a time domain associated with transmission of the third signaling at a second time after the first time, where the one or more offsets are based on one or more of the first time, the DTX cycle, or the DRX cycle. This capability accounts for network inactive periods in transmission timing calculations, ensuring reference signals are transmitted during defined active periods for reliable reception. Additionally, or alternatively, the processor 700 may be configured to or operable to support at least one of the second signaling or the first signaling indicates the one or more offsets. The explicit offset indication provides timing control that reduces signaling overhead, while ensuring accurate coordination with network active periods. Additionally, or alternatively, the processor 700 may be configured to or operable to support the second signaling includes an indicator that triggers determining the one or more offsets based on an OFF duration associated with at least one of the DTX cycle or the DRX cycle. The implicit offset determination reduces signaling overhead, while automatically adapting transmission timing to NES patterns. Additionally, or alternatively, the processor 700 may be configured to or operable to support to receive, after the second signaling, fourth signaling that indicates a change in a slot format associated with the third signaling, and drop transmission of at least a portion of the third signaling or reception of at least an additional portion of fifth signaling including at least one reference signal based on the change in the slot format. The dynamic adaptation to slot format changes prevents transmission errors and maintains system reliability during network reconfiguration events.

Additionally, or alternatively, the processor 700 may be configured to or operable to support the resource configuration is associated with a maximum latency in a time domain, and the third signaling is transmitted in a resource that satisfies the maximum latency. The latency criterion ensures timely delivery of CSI, while accommodating NES cycles, maintaining quality of service criterion. Additionally, or alternatively, the processor 700 may be configured to or operable to support the second signaling includes at least one of a common activation DCI received prior to an ON duration of the DTX cycle or an ON duration of the DRX cycle or a dedicated DCI received during the ON duration of the DTX cycle, and the common activation DCI and the dedicated DCI include at least one field that indicates one or more of a first resource configuration of the set of one or more resource configurations corresponding to a first reference signal or a second resource configuration of the set of one or more resource configurations corresponding to a second reference signal. The flexible activation mechanism enables efficient resource triggering that can accommodate both group and individual device configurations, while coordinating with network active periods. Additionally, or alternatively, the processor 700 may be configured to or operable to support the first signaling includes RRC signaling, and respective TDRA associated with the resource configurations of the set of one or more resource configurations are based on the respective DTX cycles and the DRX cycles. The TDRA alignment with DTX and DRX cycles reduces real-time signaling overhead, while ensuring timing coordination for reference signal transmissions.

The processor 700 may be configured to or operable to support at least one controller (e.g., the controller 702) coupled with at least one memory (e.g., the memory 704) and configured to cause the processor to transmit first signaling that indicates a set of one or more resource configurations, where resource configurations of the set of one or more resource configurations are associated with respective DTX cycles and DRX cycles corresponding to the NE, transmit second signaling that indicates a resource configuration of the set of one or more resource configurations and that indicates a DTX cycle and a DRX cycle of the respective DTX cycles and the DRX cycles, and receive third signaling based on the resource configuration and at least one of the DTX cycle or the DRX cycle. In this manner, the processor 700 enables an NE to obtain updated CSI at the beginning of active periods (e.g., ON durations), improving link adaptation efficiency and reducing the time to achieve communication performance after NES periods.

Additionally, the processor 700 may be configured to or operable to support any one or combination of to transmit, based on the DTX cycle, a CSI-RS, and receive, based on the DRX cycle and the CSI-RS, a CSI report including one or more CSI measurements, where the third signaling includes the CSI report. The coordinated transmission and reception ensures that channel measurements are performed when the network is transmitting and reported when the network is monitoring, providing accurate CSI for efficient resource allocation and link adaptation. Additionally, or alternatively, the processor 700 may be configured to or operable to support to receive, based on the DRX cycle, an SRS. This capability enables the network to obtain uplink channel quality measurements during active reception periods, facilitating improved uplink scheduling and beamforming decisions. Additionally, or alternatively, the second signaling is received at a first time, and the processor 700 may be configured to or operable to support to determine one or more offsets in a time domain associated with reception of the third signaling at a second time after the first time, where the one or more offsets are based on one or more of the first time, the DTX cycle, or the DRX cycle. The offset calculation ensures that the network expects to receive signaling during defined active periods, improving reception reliability and reducing processing overhead. Additionally, or alternatively, the processor 700 may be configured to or operable to support to transmit, after the second signaling, fourth signaling that indicates a change in a slot format associated with the third signaling, and drop reception of at least a portion of the third signaling or transmission of at least an additional portion of fifth signaling including at least one reference signal based on the change in the slot format. The adaptive behavior maintains system integrity during dynamic slot format changes, while preventing reception errors and resource conflicts.

Additionally, or alternatively, the processor 700 may be configured to or operable to support the resource configuration is associated with a maximum latency in a time domain, and the third signaling is received in a resource that satisfies the maximum latency. The latency management ensures that CSI is received within defined time bounds, maintaining service quality, while accommodating NES operations. Additionally, or alternatively, the processor 700 may be configured to or operable to support the second signaling includes at least one of a common activation DCI transmitted prior to an ON duration of the DTX cycle or an ON duration of the DRX cycle or a dedicated DCI transmitted during the ON duration of the DTX cycle, and the common activation DCI and the dedicated DCI include at least one field that indicates one or more of a first resource configuration of the set of one or more resource configurations corresponding to a first reference signal or a second resource configuration of the set of one or more resource configurations corresponding to a second reference signal. The flexible signaling approach enables efficient activation of multiple reference signal types, while coordinating with network active periods, reducing signaling overhead and improving resource utilization. Additionally, or alternatively, the processor 700 may be configured to or operable to support the first signaling includes RRC signaling, and respective TDRA associated with the resource configurations of the set of one or more resource configurations are based on the respective DTX cycles and the DRX cycles. The alignment of TDRAs with NES cycles reduces real-time coordination overhead, while ensuring efficient timing for reference signal reception and transmission.

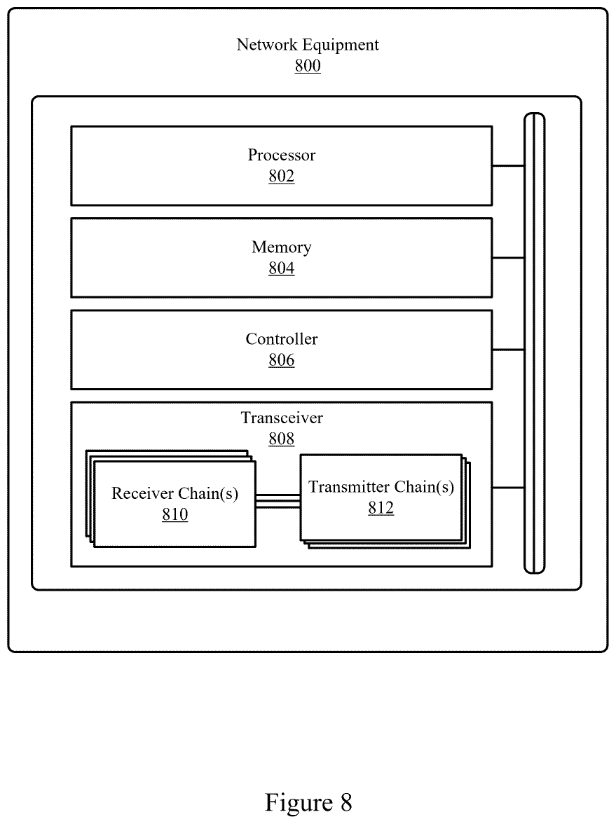

FIG. 8 illustrates an example of an NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to or operable to support a means for transmitting first signaling that indicates a set of one or more resource configurations, where resource configurations of the set of one or more resource configurations are associated with respective DTX cycles and DRX cycles corresponding to the NE, transmitting second signaling that indicates a resource configuration of the set of one or more resource configurations and that indicates a DTX cycle and a DRX cycle of the respective DTX cycles and the DRX cycles, and receiving third signaling based on the resource configuration and at least one of the DTX cycle or the DRX cycle. In this manner, the NE 800 enables coordinated transmission and reception timing that aligns with NES cycles, improving CSI accuracy and reducing power consumption, while maintaining communication efficiency.

Additionally, the NE 800 may be configured to or operable to support any one or combination of transmitting, based on the DTX cycle, a CSI-RS, and receiving, based on the DRX cycle and the CSI-RS, a CSI report including one or more CSI measurements, where the third signaling includes the CSI report. The coordinated transmission and reception ensures that channel measurements are performed when the network is transmitting and reported when the network is monitoring, providing accurate CSI for efficient resource allocation and link adaptation. Additionally, or alternatively, the NE 800 may be configured to support receiving, based on the DRX cycle, an SRS. This capability enables the network to obtain uplink channel quality measurements during active reception periods, facilitating improved uplink scheduling and beamforming decisions. Additionally, or alternatively, the second signaling is received at a first time, and the NE 800 may be configured to support determining one or more offsets in a time domain associated with reception of the third signaling at a second time after the first time, where the one or more offsets are based on one or more of the first time, the DTX cycle, or the DRX cycle. The offset calculation ensures that the network expects to receive signaling during defined active periods, improving reception reliability and reducing processing overhead. Additionally, or alternatively, the NE 800 may be configured to or operable to support transmitting, after the second signaling, fourth signaling that indicates a change in a slot format associated with the third signaling, and dropping reception of at least a portion of the third signaling or transmission of at least an additional portion of fifth signaling including at least one reference signal based on the change in the slot format. The adaptive behavior maintains system integrity during dynamic slot format changes, while preventing reception errors and resource conflicts.

Additionally, or alternatively, the NE 800 may be configured to or operable to support the resource configuration is associated with a maximum latency in a time domain, and the third signaling is received in a resource that satisfies the maximum latency. The latency management ensures that CSI is received within defined time bounds, maintaining service quality, while accommodating NES operations. Additionally, or alternatively, the NE 800 may be configured to or operable to support the second signaling includes at least one of a common activation DCI transmitted prior to an ON duration of the DTX cycle or an ON duration of the DRX cycle or a dedicated DCI transmitted during the ON duration of the DTX cycle, and the common activation DCI and the dedicated DCI include at least one field that indicates one or more of a first resource configuration of the set of one or more resource configurations corresponding to a first reference signal or a second resource configuration of the set of one or more resource configurations corresponding to a second reference signal. The flexible signaling approach enables efficient activation of multiple reference signal types, while coordinating with network active periods, reducing signaling overhead and improving resource utilization. Additionally, or alternatively, the NE 800 may be configured to or operable to support the first signaling includes RRC signaling, and respective TDRA associated with the resource configurations of the set of one or more resource configurations are based on the respective DTX cycles and the DRX cycles. The alignment of TDRAs with NES cycles reduces real-time coordination overhead, while ensuring efficient timing for reference signal reception and transmission.

Additionally, or alternatively, the NE 800 may support at least one memory (e.g., the memory 804) and at least one processor (e.g., the processor 802) coupled with the at least one memory and configured to or operable to cause the NE to transmit first signaling that indicates a set of one or more resource configurations, where resource configurations of the set of one or more resource configurations are associated with respective DTX cycles and DRX cycles corresponding to the NE, transmit second signaling that indicates a resource configuration of the set of one or more resource configurations and that indicates a DTX cycle and a DRX cycle of the respective DTX cycles and the DRX cycles, and receive third signaling based on the resource configuration and at least one of the DTX cycle or the DRX cycle.

Additionally, the NE 800 may be configured to or operable to support any one or combination of to transmit, based on the DTX cycle, a CSI-RS, and receive, based on the DRX cycle and the CSI-RS, a CSI report including one or more CSI measurements, where the third signaling includes the CSI report. Additionally, or alternatively, the NE 800 may be configured to support to receive, based on the DRX cycle, an SRS. Additionally, or alternatively, the second signaling is received at a first time, and the NE 800 may be configured to or operable to support to determine one or more offsets in a time domain associated with reception of the third signaling at a second time after the first time, where the one or more offsets are based on one or more of the first time, the DTX cycle, or the DRX cycle. Additionally, or alternatively, the NE 800 may be configured to or operable to support to transmit, after the second signaling, fourth signaling that indicates a change in a slot format associated with the third signaling, and drop reception of at least a portion of the third signaling or transmission of at least an additional portion of fifth signaling including at least one reference signal based on the change in the slot format.

Additionally, or alternatively, the NE 800 may be configured to or operable to support the resource configuration is associated with a maximum latency in a time domain, and the third signaling is received in a resource that satisfies the maximum latency. Additionally, or alternatively, the NE 800 may be configured to or operable to support the second signaling includes at least one of a common activation DCI transmitted prior to an ON duration of the DTX cycle or an ON duration of the DRX cycle or a dedicated DCI transmitted during the ON duration of the DTX cycle, and the common activation DCI and the dedicated DCI include at least one field that indicates one or more of a first resource configuration of the set of one or more resource configurations corresponding to a first reference signal or a second resource configuration of the set of one or more resource configurations corresponding to a second reference signal. Additionally, or alternatively, the NE 800 may be configured to or operable to support the first signaling includes RRC signaling, and respective TDRA associated with the resource configurations of the set of one or more resource configurations are based on the respective DTX cycles and the DRX cycles.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., an LNA) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

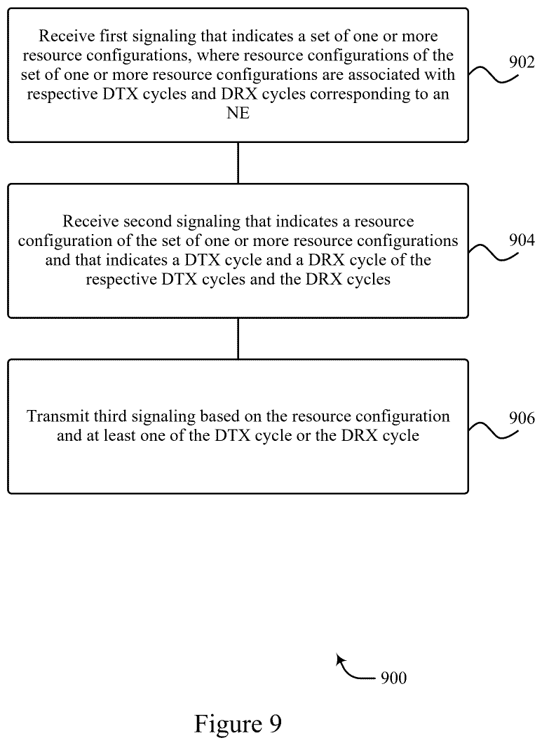

FIG. 9 illustrates a flowchart of a method 900 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 902, the method may include receiving first signaling that indicates a set of one or more resource configurations, where resource configurations of the set of one or more resource configurations are associated with respective DTX cycles and DRX cycles corresponding to an NE. The operations of 902 may be performed in accordance with examples as described herein. In some implementations, aspects of the operations of 902 may be performed by a UE as described with reference to FIG. 6.

At 904, the method may include receiving second signaling that indicates a resource configuration of the set of one or more resource configurations and that indicates a DTX cycle and a DRX cycle of the respective DTX cycles and the DRX cycles. The operations of 904 may be performed in accordance with examples as described herein. In some implementations, aspects of the operations of 904 may be performed by a UE as described with reference to FIG. 6.

At 906, the method may include transmitting third signaling based on the resource configuration and at least one of the DTX cycle or the DRX cycle. The operations of 906 may be performed in accordance with examples as described herein. In some implementations, aspects of the operations of 906 may be performed a UE as described with reference to FIG. 6.

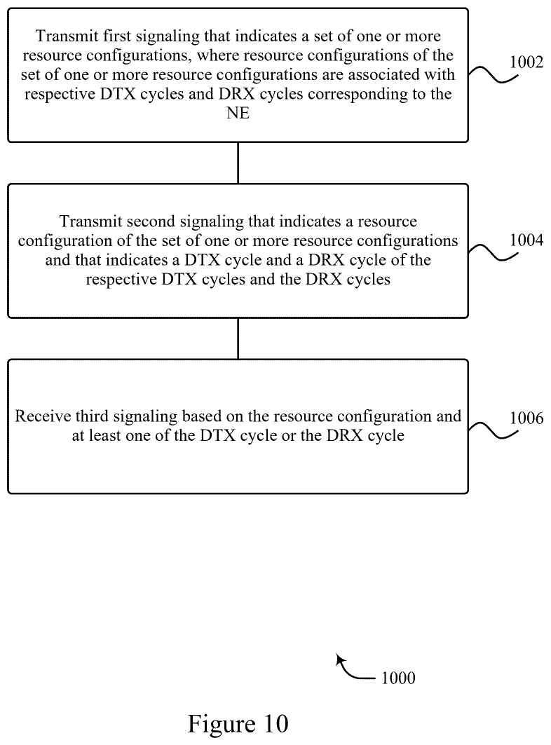

FIG. 10 illustrates a flowchart of a method 1000 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1002, the method may include transmitting first signaling that indicates a set of one or more resource configurations, where resource configurations of the set of one or more resource configurations are associated with respective DTX cycles and DRX cycles corresponding to the NE. The operations of 1002 may be performed in accordance with examples as described herein. In some implementations, aspects of the operations of 1002 may be performed by an NE as described with reference to FIG. 8.

At 1004, the method may include transmitting second signaling that indicates a resource configuration of the set of one or more resource configurations and that indicates a DTX cycle and a DRX cycle of the respective DTX cycles and the DRX cycles. The operations of 1004 may be performed in accordance with examples as described herein. In some implementations, aspects of the operations of 1004 may be performed by an NE as described with reference to FIG. 8.

At 1006, the method may include receiving third signaling based on the resource configuration and at least one of the DTX cycle or the DRX cycle. The operations of 1006 may be performed in accordance with examples as described herein. In some implementations, aspects of the operations of 1006 may be performed an NE as described with reference to FIG. 8.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive first signaling that indicates a set of one or more resource configurations, wherein resource configurations of the set of one or more resource configurations are associated with respective discontinuous transmission (DTX) cycles and discontinuous reception (DRX) cycles corresponding to a network equipment (NE);
receive second signaling that indicates a resource configuration of the set of one or more resource configurations and that indicates a DTX cycle and a DRX cycle of the respective DTX cycles and the DRX cycles; and
transmit third signaling based at least in part on the resource configuration and at least one of the DTX cycle or the DRX cycle.

2. The UE of claim 1, wherein the at least one processor is further operable to cause the UE to:
receive, based at least in part on the DTX cycle, a channel state information-reference signal (CSI-RS);
perform one or more CSI measurements based at least in part on the CSI-RS; and
transmit, based at least in part on the DRX cycle, a CSI report comprising the one or more CSI measurements, wherein the third signaling comprises the CSI report.

3. The UE of claim 1, the at least one processor is further operable to cause the UE to transmit, based at least in part on the DRX cycle, a sounding reference signal (SRS).

4. The UE of claim 1, wherein the second signaling is received at a first time, and wherein the at least one processor is further operable to cause the UE to determine one or more offsets in a time domain associated with transmission of the third signaling at a second time after the first time, wherein the one or more offsets are based at least in part on one or more of the first time, the DTX cycle, or the DRX cycle.

5. The UE of claim 4, wherein at least one of the second signaling or the first signaling indicates the one or more offsets.

6. The UE of claim 4, wherein the second signaling comprises an indicator that triggers determining the one or more offsets based at least in part on an OFF duration associated with at least one of the DTX cycle or the DRX cycle.

7. The UE of claim 1, wherein the at least one processor is further operable to cause the UE to:
receive, after the second signaling, fourth signaling that indicates a change in a slot format associated with the third signaling; and
drop transmission of at least a portion of the third signaling or reception of at least an additional portion of fifth signaling comprising at least one reference signal based at least in part on the change in the slot format.

8. The UE of claim 1, wherein the resource configuration is associated with a maximum latency in a time domain, and wherein the third signaling is transmitted in a resource that satisfies the maximum latency.

9. The UE of claim 1, wherein the second signaling comprises at least one of a common activation downlink control information (DCI) received prior to an ON duration of the DTX cycle or an ON duration of the DRX cycle or a dedicated DCI received during the ON duration of the DTX cycle, and wherein the common activation DCI and the dedicated DCI comprise at least one field that indicates one or more of a first resource configuration of the set of one or more resource configurations corresponding to a first reference signal or a second resource configuration of the set of one or more resource configurations corresponding to a second reference signal.

10. The UE of claim 1, wherein the first signaling comprises radio resource control (RRC) signaling, and wherein respective time domain resource allocation (TDRA) associated with the resource configurations of the set of one or more resource configurations are based at least in part on the respective DTX cycles and the DRX cycles.

11. A method performed by a user equipment (UE), the method comprising:
receiving first signaling that indicates a set of one or more resource configurations, wherein resource configurations of the set of one or more resource configurations are associated with respective discontinuous transmission (DTX) cycles and discontinuous reception (DRX) cycles corresponding to a network equipment (NE);
receiving second signaling that indicates a resource configuration of the set of one or more resource configurations and that indicates a DTX cycle and a DRX cycle of the respective DTX cycles and the DRX cycles; and
transmitting third signaling based at least in part on the resource configuration and at least one of the DTX cycle or the DRX cycle.

12. A network equipment (NE) for wireless communication, comprising:
at least one memory; and
at least one processor coupled with the at least one memory and operable to cause the NE to:
transmit first signaling that indicates a set of one or more resource configurations, wherein resource configurations of the set of one or more resource configurations are associated with respective discontinuous transmission (DTX) cycles and discontinuous reception (DRX) cycles corresponding to the NE;
transmit second signaling that indicates a resource configuration of the set of one or more resource configurations and that indicates a DTX cycle and a DRX cycle of the respective DTX cycles and the DRX cycles; and
receive third signaling based at least in part on the resource configuration and at least one of the DTX cycle or the DRX cycle.

13. The NE of claim 12, wherein the at least one processor is further operable to cause the NE to:
transmit, based at least in part on the DTX cycle, a channel state information-reference signal (CSI-RS); and
receive, based at least in part on the DRX cycle and the CSI-RS, a CSI report comprising one or more CSI measurements, wherein the third signaling comprises the CSI report.

14. The NE of claim 12, the at least one processor is further operable to cause the NE to receive, based at least in part on the DRX cycle, a sounding reference signal (SRS).

15. The NE of claim 12, wherein the second signaling is received at a first time, and wherein the at least one processor is further operable to cause the NE to determine one or more offsets in a time domain associated with reception of the third signaling at a second time after the first time, wherein the one or more offsets are based at least in part on one or more of the first time, the DTX cycle, or the DRX cycle.

16. The NE of claim 12, wherein the at least one processor is further operable to cause the NE to:
transmit, after the second signaling, fourth signaling that indicates a change in a slot format associated with the third signaling; and
drop reception of at least a portion of the third signaling or transmission of at least an additional portion of fifth signaling comprising at least one reference signal based at least in part on the change in the slot format.

17. The NE of claim 12, wherein the resource configuration is associated with a maximum latency in a time domain, and wherein the third signaling is received in a resource that satisfies the maximum latency.

18. The NE of claim 12, wherein the second signaling comprises at least one of a common activation downlink control information (DCI) transmitted prior to an ON duration of the DTX cycle or an ON duration of the DRX cycle or a dedicated DCI transmitted during the ON duration of the DTX cycle, and wherein the common activation DCI and the dedicated DCI comprise at least one field that indicates one or more of a first resource configuration of the set of one or more resource configurations corresponding to a first reference signal or a second resource configuration of the set of one or more resource configurations corresponding to a second reference signal.

19. The NE of claim 12, wherein the first signaling comprises radio resource control (RRC) signaling, and wherein respective time domain resource allocation (TDRA) associated with the resource configurations of the set of one or more resource configurations are based at least in part on the respective DTX cycles and the DRX cycles.

20. A method performed by a network equipment (NE), the method comprising:
transmitting first signaling that indicates a set of one or more resource configurations, wherein resource configurations of the set of one or more resource configurations are associated with respective discontinuous transmission (DTX) cycles and discontinuous reception (DRX) cycles corresponding to the NE;
transmitting second signaling that indicates a resource configuration of the set of one or more resource configurations and that indicates a DTX cycle and a DRX cycle of the respective DTX cycles and the DRX cycles; and
receiving third signaling based at least in part on the resource configuration and at least one of the DTX cycle or the DRX cycle.
